(19) United States
(12) Patent Application Publication
(10) Pub. No.: US 2025/0067685 A1
(43) Pub. Date: Feb. 27, 2025

(54) METHOD AND SYSTEM FOR MATCHING CALIBRATIONS OF DETECTORS IN A DETECTOR ARRAY

(71) Applicant: Thermo EGS Gauging LLC, Wilmington, DE (US)

(72) Inventor: Carter WATSON, Nashua, NH (US)

(21) Appl. No.: 18/812,779

(22) Filed: Aug. 22, 2024

Related U.S. Application Data
(60) Provisional application No. 63/578,415, filed on Aug. 24, 2023.

(51) Int. Cl. G01N 23/04

(52) U.S. Cl. CPC G01N 23/04; G01N 2223/1016; G01N 2223/303; G01N 2223/309; G01N 2223/604; G01N 2223/6116

(57) ABSTRACT

A method and system for checking a gauge response is described. The method includes positioning samples with known profiles and uniform compositions between a radiation source and a subset of detectors in a detector array linearly arranged in a first direction. Sample signals are generated by irradiating the samples with radiation from the radiation source and detecting radiation transmitted through the samples and to the subset of detectors. The method includes inputting the sample signals into calibrations for each of the subset of detectors and each of the one or more samples, thereby determining values corresponding to each of the one or more samples and each of the subset of detectors. The method determines if the values corresponding to the one or more samples are consistent with the know values of the samples, and thereby provides an indication as to the state of calibration of the gauge.

### CROSS-REFERENCE TO RELATED APPLICATIONS

This application claims the benefit under 35 U.S.C. § 119 (e) of U.S. Provisional Application No. 63/578,415 filed Aug. 24, 2023. The entire contents of the aforementioned application are incorporated by reference herein.

### FIELD OF THE INVENTION

This invention is directed to detector arrays. In particular, methods for troubleshooting detector calibrations in a detector array.

### BACKGROUND OF THE INVENTION

Detectors for electromagnetic radiation can be arranged as an array, such as in a line or to cover an area. This arrangement allows detection of radiation over a large area simultaneously. In gauging systems, such as x-ray or IR systems, or in x-ray screening systems, such as for parcels, freight, or mail, a detector array can be arranged under a screening area or space and a beam from a source can be directed through the screening area and to the detectors in the detector array. This allows quantitative or qualitative measurement by detecting the decrease in transmission through an object in the screening area. Especially in the case of quantitative measurements, an appropriate calibration curve is used. Since each detector responds slightly differently, each detector in the array is calibrated to ensure accuracy and precision.

A challenge with such systems is ensuring that each detector in the detector array has a matching response when properly calibrated. For example, if a web moving in the machine direction (MD) is being measured by an array of detectors oriented in the cross-machine direction (CD), streaks might be seen in the web direction (WD) if one or more of the detectors are not properly calibrated to the desired resolution. Conversely, the appearance of a streak may in-fact be a real feature of the web. Apart from re-calibrating the detectors and re-measuring the web, there is no good way to determine the source of a streak and correct the data and calibration curves if necessary.

There is therefore an unmet need for troubleshooting and matching calibrations of detectors in a detector arrays.

### SUMMARY

Systems, methods, and products to address these and other needs are described herein with respect to illustrative, non-limiting, implementations. Various alternatives, modifications and equivalents are possible.

According to a first aspect, a method for checking a gauge response is described. The method includes positioning, one at a time, one or more samples with known profiles and uniform compositions in one or more positions between a radiation source and a subset of detectors in a detector array linearly arranged in a first direction. The method also includes generating sample signals by irradiating the samples with radiation from the radiation source and detecting radiation transmitted through the samples and to the subset of detectors. In another step, the method includes inputting the sample signals into calibration curves for each of the subset of detectors and each of the one or more samples, thereby determining values corresponding to each of the one or more samples and each of the subset of detectors. The method provides a first indication if the values corresponding to the one or more samples are consistent with the know profiles and uniform compositions of the samples.

According to a second aspect, a system for checking a gauge response is described. The system includes a radiation source, a detector array arranged in a first direction, a sample holder, a space between the source and the detector array, and a computing device having executable code stored thereon. The executable code is configured to send instructions for one or more of: positioning, one at a time, one or more samples with known profiles and uniform compositions that are in the sample holder, in one or more positions between the radiation source and a subset of detectors in the array of detectors; generating sample signals by irradiating the samples with radiation from the radiation source and detecting radiation transmitted through the samples and to the subset of detectors; inputting the sample signals into calibration curves for each of the subset of detectors and each of the one or more samples, thereby determining values corresponding to each of the one or more samples and each of the subset of detectors; and providing a first indication if the values corresponding to the one or more samples are consistent with the know profiles and uniform compositions of the samples.

According to a third aspect, one or more non-transitory computer readable media having instructions thereon is described. When executed by one or more processing devices of a gauging instrument, the one or more non-transitory computer readable media cause the gauging instrument to perform the method according to the first aspect.

The methods, systems and non-transitory media provide fulfill the unmet need of troubleshooting and matching calibrations of detectors in a detector arrays.

### BRIEF DESCRIPTION OF THE DRAWINGS

The foregoing and other features and advantages of the present embodiments will be more fully understood from the following detailed description of illustrative embodiments taken in conjunction with the accompanying drawings.

FIGS. 1A and 1B show a gauging or screening instrument, according to some implementations.

FIGS. 1C and 1D show the gauging instrument of FIGS. 1A and 1B with a sample holder that can be included according to some implementations.

FIG. 2A illustrates a method for checking a gauge response, according to some implementations.

FIG. 2B is a flow diagram showing the steps for the method illustrated by FIG. 2A.

FIG. 3 illustrates indications provided by the methods and systems described herein, according to some implementations.

FIG. 4A-4D show radiation beams impinging on a sample 101 and on the detectors in a subset of detectors, according to some implementations. FIG. 4A shows a sample with an imperfection and FIG. 4B shows the sample with the imperfection translated along a detector array. FIG. 4C shows a sample and FIG. 4D shows the sample translated along a detector array.

FIG. 5 is a flow diagram showing the steps for detecting a possible streak in a sample, according to some implementations.

FIG. 6 shows a topographical map of a wafer that is scanned according to the method described with reference to FIG. 5.

FIG. 7 is a block diagram of the computing device 700 that may perform some or all of the method steps described herein, according to some implementations.

FIG. 8 is a block diagram of an example scientific instrument support system in which some or all the methods disclosed herein may be performed, in accordance with various implementations.

FIG. 9 is a block diagram of a system 900 for checking a gauge response, according to some implementations.

The figures referred to above are not drawn necessarily to scale, should be understood to provide a representation of particular embodiments, and are merely conceptual in nature and illustrative of the principals involved. The same reference numbers are used in the drawings for similar or identical components and features shown in various alternative embodiments.

### DETAILED DESCRIPTION

In the description of the invention herein, it is understood that a word appearing in the singular encompasses its plural counterpart, and a word appearing in the plural encompasses its singular counterpart, unless implicitly or explicitly understood or stated otherwise. Furthermore, it is understood that for any given component or embodiment described herein, any of the possible candidates or alternatives listed for that component may generally be used individually or in combination with one another, unless implicitly or explicitly understood or stated otherwise. Moreover, it is to be appreciated that the figures, as shown herein, are not necessarily drawn to scale, wherein some of the elements may be drawn merely for clarity of the invention. Also, reference numerals may be repeated among the various figures to show corresponding or analogous elements. Additionally, it will be understood that any list of such candidates or alternatives is merely illustrative, not limiting, unless implicitly or explicitly understood or stated otherwise. In addition, unless otherwise indicated, numbers expressing quantities of ingredients, constituents, reaction conditions and so forth used in the specification and claims are to be understood as being modified by the term “about.”

Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the statistical dispersion found in their respective testing measurements.

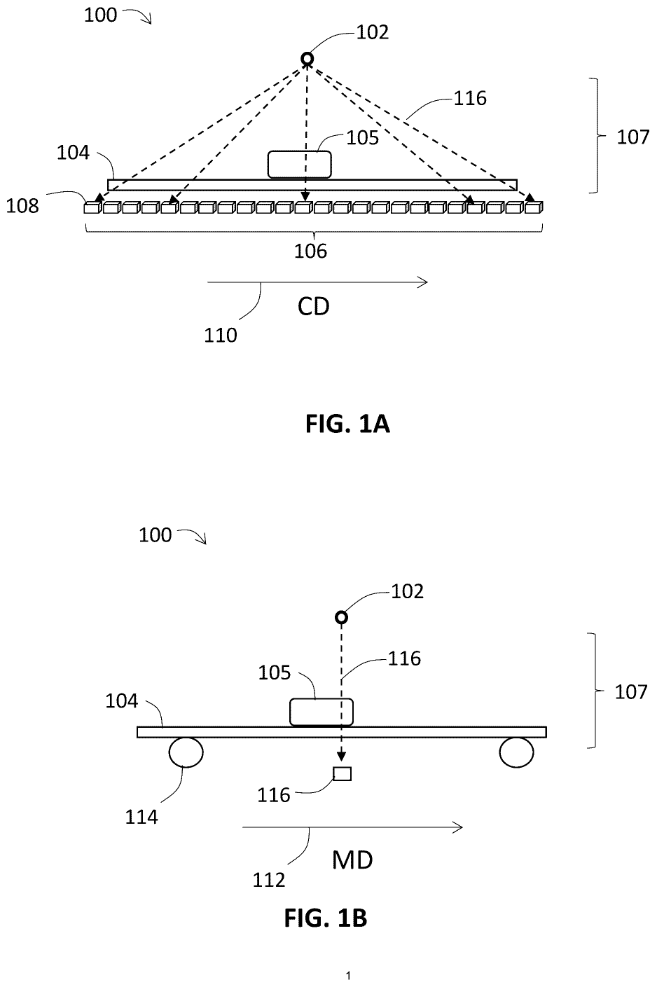

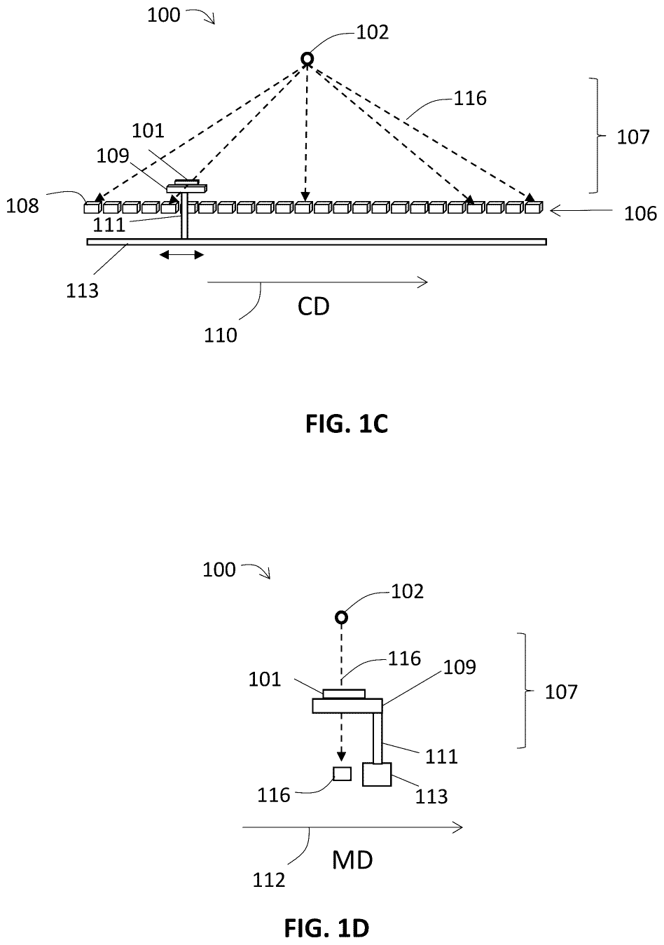

FIGS. 1A and 1B show a gauging or screening instrument 100, according to some implementations. The gauging instrument 100 includes a radiation source 102, a web 104, and a detector array 106. FIG. 1A shows a front view and FIG. 1B shows a side view. The detector array 106 includes a plurality of detectors 108 that are oriented in a first direction 110, which corresponds to the CD. The web 104 travels in a second direction 112, which corresponds here to the MD, and can be supported by guiding elements 114. The radiation source 102 as depicted is a point source which provides radiation 116 as a fan-beam which strikes the detector array 106 after passing through the web 104. The web 104 itself can be the object under investigation, such as a thin film, or an item 105 can be place on the web 104 (e.g., a conveyor belt) where the item 105 is passed through a space 107 between the radiation source 102 and the array.

FIGS. 1C and 1D show the gauging instrument 100 with a sample holder 109 that can be included in some implementations. FIG. 1C is a front view and FIG. 1D is a side view. The sample holder 109 can move in the first direction 110 to move the holder 109 in the radiation 116 in the space 107. In some implementations, the sample holder 109 can also move in the second direction 112, so that the sample holder 109 acts as an “xy” stage. The sample holder can be connected by an arm 111 to a rail 113 to move the sample holder in the first direction 110. The rail 113 can be longer than the detector array 106 so that the sample holder 109 can be moved out of the radiation 116. The sample holder can also include other or alternative elements such as rails, actuators, and screws, and motors, to move the sample holder 109 in the second direction 112. In some implementations, the sample holder 109 is an xyz stage and includes elements to move the holder in a third direction that is orthogonal to the first direction 110 and the second direction 112. In some implementations, the holder can accommodate more than one sample 101 at a time. For example, the sample holder can accommodate a plurality the samples 101 next to each other on the sample holder 109 so that each can be positioned between the radiation 116 and the detectors 108, where the samples 101 do not overlap. In some implementations, the samples 101 can be stacked (overlap) so that the radiation 116 passes through the stacked sample 101 before reaching the detectors 108.

It is appreciated that a scanning beam that rasters in the CD direction can also be used, or multiple fan-beams that span the detector array 106 can be used. Additionally, more than one row of detectors 108 can be used for the detector array 106, such as two or more adjacent rows oriented in the MD direction. In some implementations, the radiation source 102 is an x-ray source.

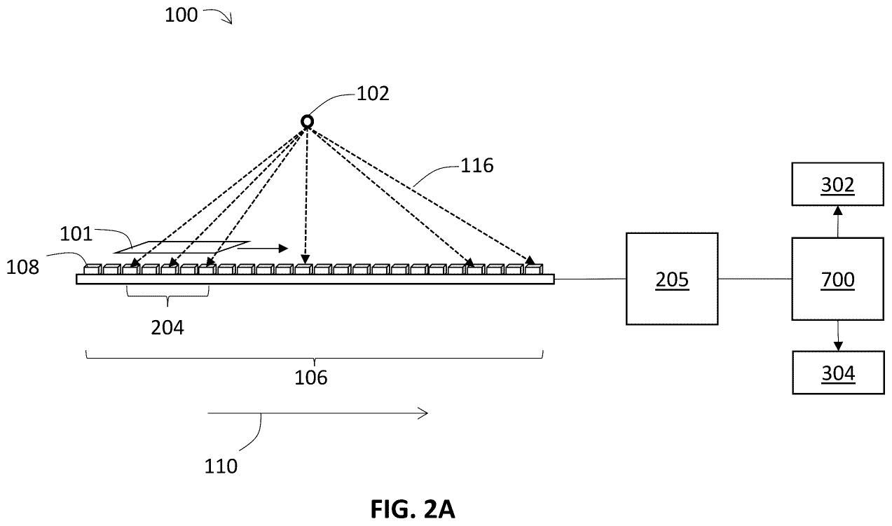

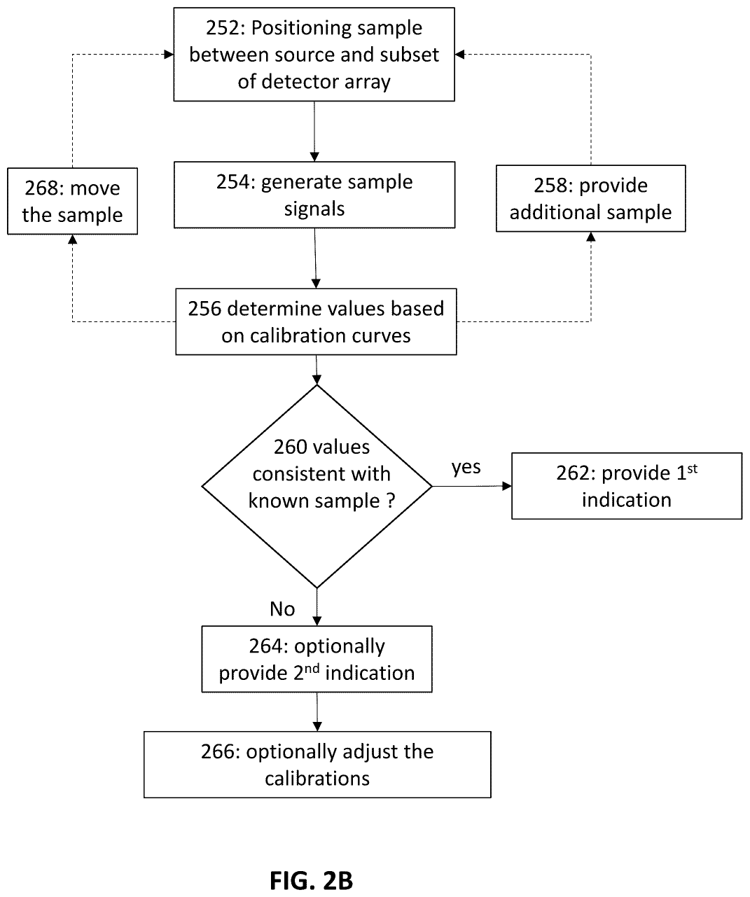

FIG. 2A illustrates a method for checking a gauge response, according to some implementations. Using the gauging instrument 100, a sample 101 is positioned between the radiation source 102 and a subset of detectors 204 of the detector array 106 which is linearly arranged in the first direction 110. The sample 101 casts a shadow on the subset of detectors 204 in that it blocks some of the radiation 116 from reaching the subset of detectors 204. In some implementations, the sample 101 can be placed in the sample holder 109 (FIGS. 1C and 1D).

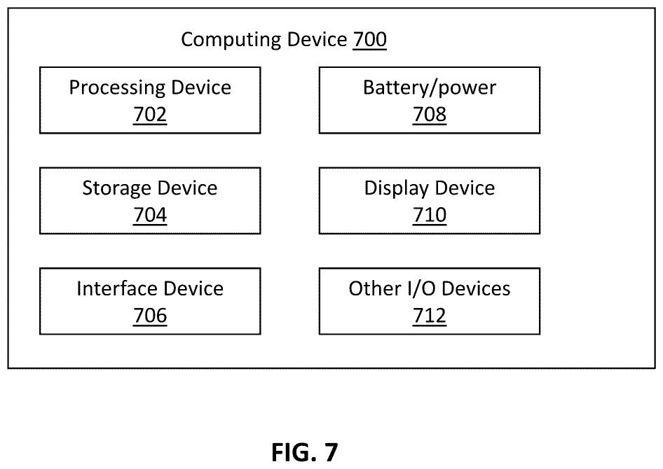

Sample signals are generated by irradiating the sample 101 with radiation 116 from the radiation source 102 and detecting radiation transmitted through the sample 101 and to the subset of detectors 204. The detectors 108 include, or are in communication with, electric circuits 205 to accept as input the initial signals generated from the interaction of the radiation 116 with the detectors 108. These initial signals are amplified and digitized by the electric circuits 205 and output as the sample signals which are input into the calibration curves of the detectors 108 as described below. In some implementations, the sample signals are sent/input to a computing device 700 (which will be described in more detail below with reference to FIG. 7).

The sample signals are input into calibration curves for each of the detectors 108, at least in the subset of detectors 204, and values, such as a thickness or a basis weight, are determined for the sample 101 for each of the detectors 108. A first indication 302 is provided if the values corresponding to the one or more samples 101 are consistent with the known profiles and uniform compositions of the samples 101. As used here “consistent with” means the values are the same as expected values for the known profiles and uniform composition, within the error of the measurement or a desired and selected accuracy. The first indication 302 can be provided by the computing device 700. In some implementations, a second indication 304 is provided if the values corresponding to the one or more sample 101 are not consistent with the known profiles and uniform compositions of the samples 101. In some implementations, the calibrations are adjusted. In some implementations, the sample 101 is placed in one or more additional positions between the source 102 and the subset of detectors 204 by moving the sample 101 in the first direction 110.

The subset of detectors 204 can include between one and all of the detectors 108 in the detector array 110. The number of detectors 108 in the subset of detectors 204 depends on the length of the sample 101 in the first direction 106 as compared to the length of the array 106 in the first direction 110. That is, number of detectors 108 in the subset of detectors 204 depends on which detectors 108 are shadowed by the sample 101. In some implementations, the sample 101 shadows 1 to 80% of the detector array 106 (e.g., 1 to 50%, 1 to 10%).

Any suitable detectors 108 can be used. For example photodiodes that are sensitive or responsive to the radiation 116 can be used. The size of the diode can also be selected based on the resolution desired. For example, the pitch of the diode can range from about 0.5 mm to about 1 cm, such as from about 1 mm to 1.6 mm.

The sample 101 has a known profile. For example, the sample 101 can be concave, convex, have step changes in profile, be wedge shaped, is flat, has an irregular surface or includes regular features. In some implementations the sample 101 is flat and has a uniform profile. For example, in some implementations, the sample 101 has a total thickness variation (TTV) of less than 10 microns (e.g., less than 5 microns, less than 3 microns, or less than 1 micron).

In some implementations, the sample 101 also has a uniform composition. For example, the sample 101 can have a layered structure wherein the composition within each layer is the same while each layer can have a different composition, or the sample 101 can be substantially homogenous throughout. Here substantially homogeneous means that the bulk of the sample has a homogeneous composition with the recognition that outer surfaces may have a thin layer (e.g., 1-100 nm) of a different material, such as an oxide. In some implementations, the sample 101 has less than about 100 ppm of impurities (e.g., less than 10 ppm, less than 1 ppm, less than 100 ppb, less than 10 ppb of impurities). The sample 101 can include any element or combination of elements that can be formed into a stable structure. As used here stable means the sample 101 holds its form and composition (i.e., it is not chemically changed or degraded) during handling and irradiation with the gauging instrument 100. In some implementations, the sample 101 includes a metal or alloy. In some implementations, the sample 101 includes plastics such a polypropylene, polyethylene, polycarbonate, polyurethane. In some implementations the sample 101 includes main group elements such as carbon, silicon, germanium, oxygen, nitrogen and phosphorous. In some implementations, the sample 101 is a metal or main group oxide. The sample can even include a fluid within a container, where the container holds the form or shape of the sample.

In some implementations, the sample 101 is a semiconductor wafer or a portion thereof, such as a coupon or cut out from the semiconductor wafer. In some implementations the semiconductor wafer includes group IV elements (e.g., carbon, silicon, germanium), II-V elements (e.g., aluminum, gallium, indium, arsenic, nitrogen, phosphorous), metals (e.g., copper, tungsten, titanium). For example, the semiconductor wafer can be a silicon wafer, a silicon nitride wafer, a silicon carbide wafer, a germanium wafer, a gallium arsenide wafer, a titanium nitride wafer, a tungsten wafer, a copper wafer, or a layered combination of these (e.g., a layer of silicon nitride, titanium nitride, copper or tungsten that is deposited or grown on silicon). In some implementations, the wafer has a pattern, such as including copper, titanium, aluminum patterned on a silicon oxide surface of a silicon wafer. In some implementations the semiconductor wafer is a silicon wafer. In some implementations the semiconductor wafer is a germanium wafer. In some implementations, the sample is a single crystal, such as grown by the Czochralski method. In some implementations, the wafer is a crystalline silicon wafer and in some other implementations the wafer is a crystalline germanium wafer.

In some implementations, more than one sample 101 is used. For example, one to 100 samples 101 (e.g., 1 to 10, or 1 to 3 samples) can be used. In some implementations, samples 101 having different thickness/basis weight are used. In some implementations, the samples 101 have different compositions and different profiles. In some implementations, the samples 101 have the same compositions and the same profiles but different thicknesses/basis weights. The thickness of the sample can be measured by any suitable profilometer, or profile information can be provided from the manufacturer. The basis weight can be determined by measuring the area of sample presented to the radiation 116 (e.g., a top portion of the sample generally facing the source 102) and weighing the sample, such as with an analytical balance.

As introduced above, in some implementations, the method includes providing a first indication 302 if the value corresponding to the sample 101 is consistent with the known profiles and uniform composition of the sample 101. The first indication 302 signals that the detectors 108 are matching. As used here “matched” signifies that the detectors 108 provide the same values within the measurement limits for the same sample 101. Therefore, if the sample 101 is positioned above the subset of detectors 204, the indicator 302 implies the calibration for the detectors 108 in the subset of detectors 204 are matched, meaning they provide the same values within an expected error. This does not mean the calibration curves are the same (although this is possible) since each detector 108 generally will have a unique calibration curve due to its unique response. A second indication 304 can be provided if the value corresponding to sample 101 is not consistent with the known profile and uniform composition of the sample 101. Where the sample 101 shadows the subset of detectors 204 as shown in FIG. 2A, the second indication 304 signifies that at least one detector 108 in the subset of detectors 204 is not matched. This can be due to the calibrations of the subset of detectors 204 not matching.

FIG. 2B is a flow diagram showing the steps illustrated in FIG. 2A. In step 252 the sample 101 is positioned between the radiation source 102 and the subset of detectors 204. Sample signals are generated in step 254. In step 256 values based on the calibration curves of the detectors 108 in the subset of detectors 204 is determined. That is, the signals, such as radiation absorbance values, generated in step 254, are processed in step 256 by inputting the signals into the calibration curves established for the detectors 108. In some implementations, steps 252, 254, and 256 are repeated with one or more additional samples as indicated by step 258. In step 260 the values are assessed to determine if the values are consistent with the sample 101 known profile and uniform composition, the first indication 302 is provide in step 262. In some implementations, if the values are not consistent with the sample 101 known profile and uniform composition, the second indicator 304 is provided. In some implementations, if values are consistent within the error of the measurements the first indicator 302 is provided. In some implementations, if the values are consistent to a selected accuracy, the first indication 302 is provided. In some implementations, if values are not-consistent within the error of the measurements the second indicator 304 is provided. In some implementations, if the values are not-consistent to a selected accuracy, the second indication 304 is provided. In some implementation, the calibrations of the subset of detectors 204 are adjusted in step 266. In some implementations, the sample 101 is moved such that it is placed in one or more additional positions between the source 102 and the subset of detectors 204 and steps 252, 254 and 256 are repeated as indicted by step 268.

One or more of the steps shown in FIG. 2B can be taken out of the shown order. For example, providing more than one sample 101 as denoted by 258 can be done at any point. For example, if it is determined at step 260 that the values are consistent with the profile/composition of sample 101, a second sample can be used for confirmation after step 260 and before the first indication 302 is provided in step 262. Alternatively, if it is determined at step 260 that the value is not consistent with the profile/composition of sample 101, a second sample 101 can be used for confirmation before providing the second indication 304 at step 264, and to provide additional data for adjusting the calibrations in step 266. In some implementations, moving the sample 101 as denoted by 268 can be done before step 256 or after step 260, step 264, or step 266.

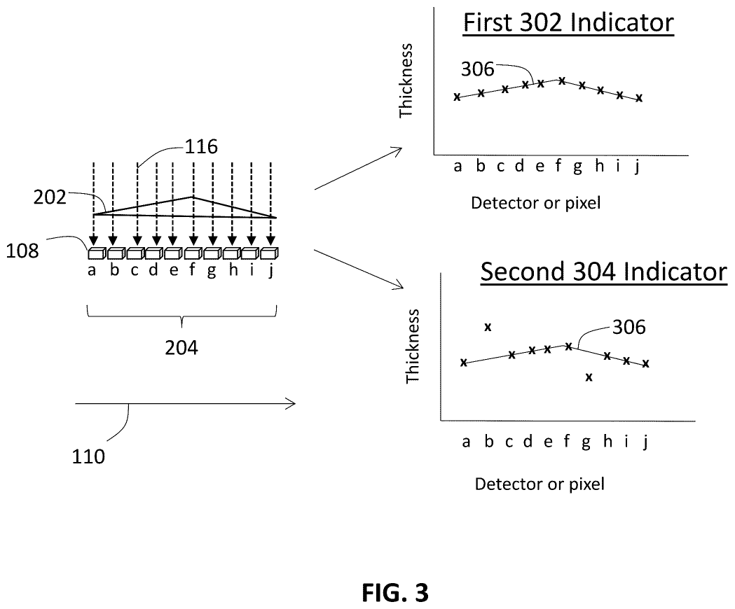

FIG. 3 illustrates the indications 302 and 304, according to some implementations. The sample 101 is irradiated with radiation 116 which then reaches the subset of detectors 204. For simplicity, the radiation 116 is shown as parallel beams striking the detectors 108 perpendicularly: however, other arrangements are possible, such as the fan-beam previously discussed where the radiation 116 would not be parallel and would strike the detectors 108 at various angles. The specific orientation of the radiation 116 to the detectors 108 is accounted for in creating the calibrations for each of the detectors 108.

The detectors 108a to 108j generate signals which are processed by inputting them into the calibration curves of each of the detectors 108a-108j to provide a value, such as a thickness. The thickness is mapped to each of the detectors 108a-108j and can be compared to the expected thickness. In the figure, this is illustrated by the first indicator 302 plot and the second indicator 304 plot, where each of these plots is a possible outcome. These plots show the expected thickness to detector 108 with designations a-j by the line 306, which matches the thickness profile of the sample 101. The “x” markers indicate individual values obtained from each of the detectors 108a-108j. In the case of the first indicator 302, all the x markers match the expected value of line 306 within the error of the measurement or a desired and selected accuracy. In the case of the second indicator 304, the x markers for detectors 108b and 108g are not close to the expected thickness. Unless the marker distance for detector 108b and 108g from the line 306 is within the error of measurement or desired accuracy, then the second indicator 304 is correctly triggered. The indicators 302, 304 are determined by an algorithm executed by the computing device 700 and although a plot can be shown through computing device 700, this is not necessary. The indicators 302, 304 can be a value or values stored in and used by the computing device 700. For example, the second indicator can include or point to data denoting which of detectors 108a-108j are not providing the expected value. In some implementations, the indicators provide a measure of how closely the values, such as represented by the x markers, match the expected values represented by line 306. For example, the indicator can be a percent of matching or a statistical value of the matching such as a p-value.

It is noted that the determination of the first indicator 302 or the second indicator 304 is a function of the amount of time the sample 101 is irradiated. Increasing the amount of irradiation time increases the accuracy of the measurement and smaller deviations from line 306 can be detected. The distance between detectors 108 or pitch also impacts the accuracy, where when the detectors 108 are closer together, deviation in the first direction 110 of the thickness of the sample 101, can be resolved to a greater degree. Any accuracy, in theory at the resolving limit of the x-ray wavelengths, can be achieved provided the irradiation time is long enough, the distance between the detectors 108 in the detector array 106 is small enough, and the sample 101 can withstand the radiation 116 without decomposition during the measurement.

In some implementations, the first indication is not provided, or the second indication is provided, signaling that at least one of the detectors 108 is not matching and might be out of calibration. In this case the detectors 108 that are out of calibration can be adjusted so that inputting the sample signals into the adjusted calibrations provides the values corresponding to the known profiles and uniform compositions of the sample 101. It is noted that after an initial calibration, a detector can go out of calibration due to a physical defect arising from use or age, such as a degradation or a contaminant on the detector, or perhaps a detector has been unintentionally moved or positioned out of alignment.

In some implementations, the detectors 108 are calibrated using calibration standards having a known thickness/basis weight. A polynomial fit of the known thickness or basis weight to x-ray transmission through the standards for each detector 108 can be generated. In some implementations, if detectors 108 are not matching, the one or more calibrations of each detector 108 that is out of calibration is adjusted by applying a correction to the polynomial fit calibration curve. In some implementations, the calibration is adjusted by an off-set (zero order adjustment). In some implementations, the calibration is adjusted by a linear correction (1^{st} order adjustment). In some implementations, the calibration is adjusted by a second, third or fourth order adjustment. The correction can be done by using known algebraic methods.

In implementations where the first indication 302 is provided, a prompt can be triggered or created to indicate the subset of detectors 204 are in calibration and functioning properly. For example, the prompt can signal to an operator which subset of detectors 204 have been measured by sample 101 and that they are all matching. If a streak is detected, this indicates to the operator the streak is not due to the subset of detectors 204.

As previously introduced, in some implementations, the sample 101 is placed in two or more positions by translating the sample 101 in the first direction. The translation can be a continuous or a stepwise movement. For a stepwise movement, the x-ray source 102 can be continuously irradiating the sample 101 and after each step the sample 101 stops and sample signals from the subset of detectors 204 can be collected for a specified time (e.g., 1 micro-second to 10 seconds) before movement to the next step. Alternatively, a shutter for the x-ray source can be closed during movement of sample 101 and opened when the sample 101 is in position shadowing the subset of detectors 204. For continuous movement, a slower movement or scan speed provides more accurate data than a faster movement.

Translating the sample 101 in the first direction 110 allows the detector array 106, having a width in the first direction 110 that is larger than the sample 101 in the same direction, to be scanned by the sample 101. If the sample 101 is made wider in the first direction 110, less translation is required to scan all of the detectors 108 in the detector array 106. A sample 101 having the same width as the detector array 106 does not need to be translated to determine if the detector array is in calibration. However, providing a large sample 101 that has a controlled and known profile as well as a uniform composition is challenging. For example, semiconductor wafers are highly uniform in both thickness and composition and current semiconductor wafers up to 300 mm in diameter are routinely made. Thus, in theory up to only about a 300 mm wide detector array 106 could all simultaneously be scanned using the current semiconductor wafer offerings.

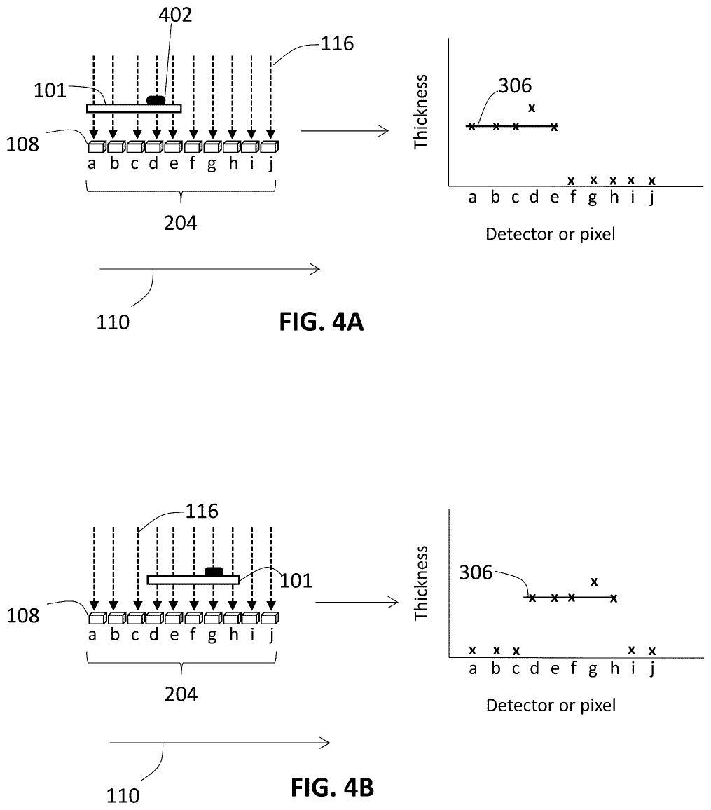

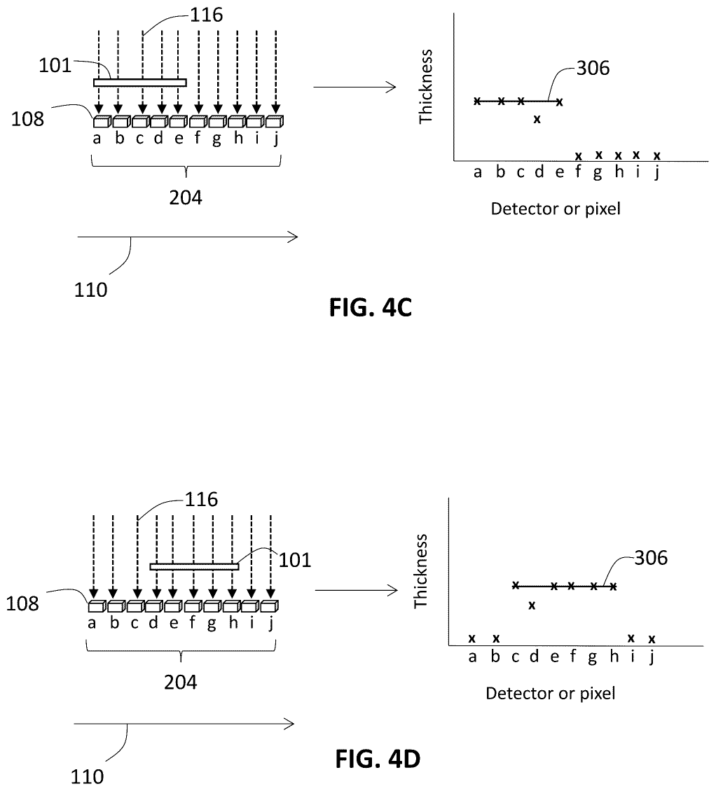

In addition to the above identified challenges in finding appropriate large sample, translating the sample 101 includes other benefits. For example, if the sample 101 is translated, a mismatched detector 108 in the detector array 106 is easily distinguished from an actual feature on the sample 101. This is illustrated by FIG. 4A-4D which show, on the left side of the page, radiation 116 beams impinging on the sample 101 and on the detectors 108a-108j in the subset of detectors 204. On the right side of the page is shown corresponding processed signals in the form of thickness values plotted against the detector 108a-108j designation. The expected thickness is shown by the line 306 and the determined values are indicated by the x marker.

In FIGS. 4A and 4B, the sample 101 includes an imperfection or feature 402. The imperfection 402 is illustrated as a raised area or a contaminant or particle, but the imperfection 402 can also include other imperfections, for example such as a groove or a part of the sample 101 having a different composition. In FIG. 4A the imperfection 402 is manifested/detected as a higher-than-expected thickness value shown corresponding to detector 108d. In FIG. 4B, the sample 101 is translated about 3 detectors in the first direction 110. The imperfection 402 is manifested/detected as a higher-than-expected thickness value shown corresponding to detector 108g, which is 3 detectors from detector 108d. If the steps taken are smaller, such as on the order of the detector 108 pitch distance, then each detector 108 would show the imperfection 402 “move” with the sample 101 as manifested by the higher-than-expected thickness value reading. Therefore, this behavior implies an imperfection or feature of the sample 101, rather than a mismatched detector 108. It is understood that the imperfection 402 can give rise to either a higher-than-expected value or a lower-than-expected value. In addition, the imperfection 402 can shadow more than one detector, causing an increase or decrease in the value for adjacent detectors rather than just for one detector.

In FIGS. 4C and 4D, the sample 101 has no detectable imperfection or feature. In FIG. 4C the sample 101 shadows detectors 108a to 108c and should give the thickness profile of line 306. However, the thickness measurement associated with detector 108d is lower than expected. In FIG. D the sample has been translated in the first direction 110 to shadow detectors 108c to 108h. The thickness measurement associated with detector 108d is still lower than expected. This is a strong indication that the detector 108d does not match the rest of the detectors 108 in the subset of detectors 204, since the lower-than-expected value does not move with the sample 101. It is understood that the thickness measurement associated with an out of matching detector 108 can cause an increase or decrease in the detected value and that more than one detector 108, adjacent or not adjacent can be out of matching with the rest of the subset of detectors 204.

Therefore, in some implementations the sample 101 is moved in the first direction 110 and the feature 402 can be confirmed as a sample feature if the markers x move commensurately with the movement of the sample 101. Otherwise, markers x that do not conform to the expected profile and uniformity of sample 101 can be attributed to mismatched detectors 108.

In some implementations, the method includes steps for identifying a streak. For example, such a steak can be identified using a web gauging process which is then confirmed as a feature of the web or as a mismatch in the detectors 108. The method therefore includes translating an object, such as the web 104 or an item 105 (FIGS. 1A and 1B), in the second direction 112 over the detector array 106 that is oriented in the first direction 110 (FIGS. 1A and 1B). Object signals are generated by irradiating the object with radiation 116 from the radiation source 102 and detecting radiation transmitted through the object and to the detector array 106 while the object is translated in the second direction 112. The object signals are input into the calibration curves for each of the detectors 108 thereby determining values corresponding to the object. A topography or heat map of the object can then be made using the values which can correspond to a thickness or basis weight, for example, a streak is identified in the topography map. The streak is associated with one or more detectors 108 in detector array 106 showing a peak or trough in object signals as compared to adjacent detectors.

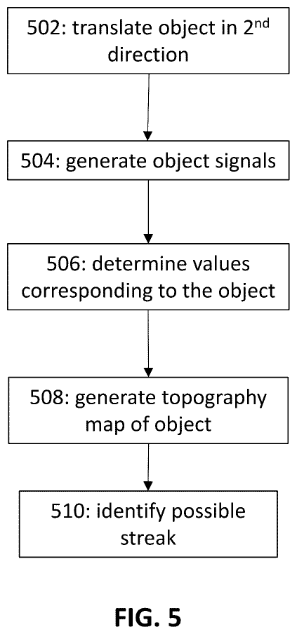

FIG. 5 is a flow diagram showing the steps for detecting a possible streak in a sample, according to some implementations. The object is translated in the second direction in step 502. Object signals are generated in step 504. Values corresponding the object are determined in step 506. A topography or heat map is generated in step 508. A possible streak is identified in step 510.

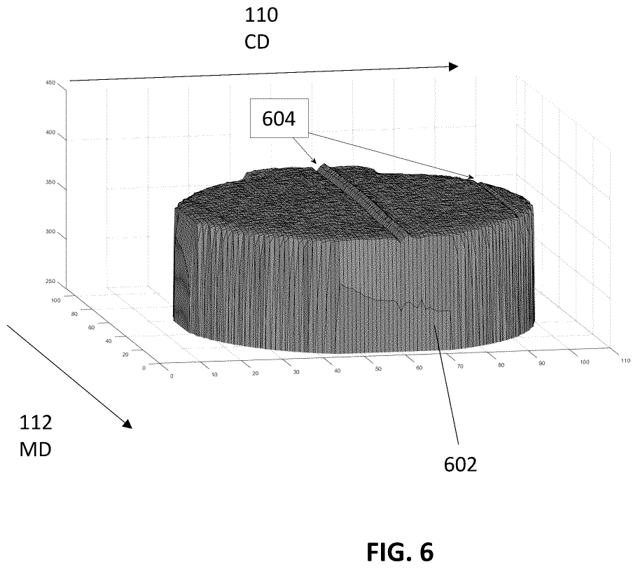

FIG. 6 shows a topographical map of a wafer 602 that is the object scanned as described with reference to FIG. 5. Two streaks 604 are found as indicated. Having found the streaks 604, the detector array 106 can be measured with the sample 101 to determine if the streaks 604 are a real feature of the wafer 602, or an artifact of mismatched detectors 108 in the detector array 106.

Without limitation, the object can be a continuous film, or individual objects such as parcels, freight, mail on a conveyor belt or similar transporting system. In some implementations, the object is a foodstuff or a pharmaceutical. In some implementation, the object are minerals or other extracts from mining. In some implementations the object is an organism such as a plant or mammal. In some implementations, the object is a vehicle such as a car, train, or truck. In some implementations, the object is a cathode or anode of a lithium-ion battery, or a precursor of these. In some implementations, the object is the separator for a lithium-ion battery.

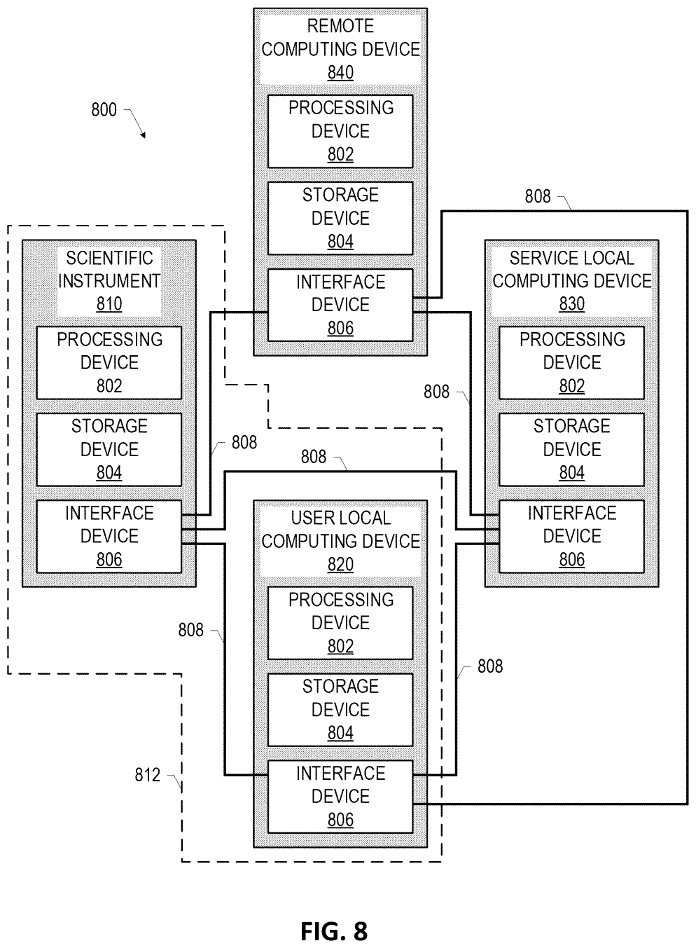

FIG. 7 is a block diagram of the computing device 700 that may perform some or all of the method steps described herein. In some implementations, the methods are implemented using a single computing device 700 or by multiple computing devices 700. Further, as discussed below, a computing device 700 (or multiple computing devices 700) that implements the methods may be part of one or more of the scientific instruments 810, described below with reference to FIG. 8, the user local computing device 820, the service local computing device 830, or the remote computing device 840.

The computing device 700 of FIG. 7 is illustrated as having a number of components, but any one or more of these components may be omitted or duplicated, as suitable for the application and setting. In some implementations, some or all of the components included in the computing device 700 may be attached to one or more motherboards and enclosed in a housing (e.g., including plastic, metal, and/or other materials). In some implementations, some these components may be fabricated onto a single system-on-a-chip (SoC) (e.g., an SoC may include one or more processing devices 702 and one or more storage devices 704). Additionally, in various implementations, the computing device 700 may not include one or more of the components illustrated in FIG. 7, but may include interface circuitry (not shown) for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device 700 may not include a display device 710, but may include display device interface circuitry (e.g., a connector and driver circuitry) to which a display device 710 may be coupled.

The computing device 700 may include a processing device 702 (e.g., one or more processing devices). As used herein, the term “processing device” may refer to any device or portion of a device that processes electronic data from registers and/or memory to transform that electronic data into other electronic data that may be stored in registers and/or memory. The processing device 702 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices.

The computing device 700 may include a storage device 704 (e.g., one or more storage devices). The storage device 4004 may include one or more memory devices such as random access memory (RAM) (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some implementations, the storage device 704 may include memory that shares a die with a processing device 702. In such an embodiment, the memory may be used as cache memory and may include embedded dynamic random access memory (cDRAM) or spin transfer torque magnetic random access memory (STT-MRAM), for example. In some implementations, the storage device 704 may include non-transitory computer readable media having instructions thereon that, when executed by one or more processing devices (e.g., the processing device 702), cause the computing device 700 to perform any appropriate ones of or portions of the methods disclosed herein. The storage device 704 can also store the calibration curves for each of the detectors 108 as well as the sample and object signals generated by irradiating the samples 101 or an object (e.g., web 104 or item 105, FIG. 1A) with radiation from the radiation source 102 and detecting radiation transmitted through the samples 101 or object and to the subset of detectors 204.

The computing device 700 may include an interface device 706 (e.g., one or more interface devices 706). The interface device 706 may include one or more communication chips, connectors, and/or other hardware and software to govern communications between the computing device 700 and other computing devices. For example, the interface device 706 may include circuitry for managing wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some implementations they might not. Circuitry included in the interface device 706 for managing wireless communications may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). In some implementations, circuitry included in the interface device 706 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some implementations, circuitry included in the interface device 706 for managing wireless communications may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some implementations, circuitry included in the interface device 4006 for managing wireless communications may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some implementations, the interface device 4006 may include one or more antennas (e.g., one or more antenna arrays) to receipt and/or transmission of wireless communications.

In some implementations, the interface device 706 may include circuitry for managing wired communications, such as electrical, optical, or any other suitable communication protocols. For example, the interface device 706 may include circuitry to support communications in accordance with Ethernet technologies. In some implementations, the interface device 706 may support both wireless and wired communication, and/or may support multiple wired communication protocols and/or multiple wireless communication protocols. For example, a first set of circuitry of the interface device 706 may be dedicated to shorter-range wireless communications such as Wi-Fi or Bluetooth, and a second set of circuitry of the interface device 706 may be dedicated to longer-range wireless communications such as global positioning system (GPS), EDGE, GPRS, CDMA, WiMAX, LTE, EV-DO, or others. In some implementations, a first set of circuitry of the interface device 706 may be dedicated to wireless communications, and a second set of circuitry of the interface device 706 may be dedicated to wired communications.

In some implementations, the interface device can input the sample signals into the calibration curves for each of the subset of detectors 204, such as from the circuit 205.

The computing device 700 may include battery/power circuitry 708. The battery/power circuitry 708 may include one or more energy storage devices (e.g., batteries or capacitors) and/or circuitry for coupling components of the computing device 700 to an energy source separate from the computing device 700 (e.g., AC line power).

The computing device 700 may include a display device 710 (e.g., multiple display devices). The display device 710 may include any visual indicators, such as a heads-up display, a computer monitor, a projector, a touchscreen display, a liquid crystal display (LCD), a light-emitting diode display, or a flat panel display. In some implementations, the display device can show real time processing information such as thickness or basis weights across the web 104.

The computing device 700 may include other input/output (I/O) devices 712. The other I/O devices 712 may include one or more audio output devices (e.g., speakers, headsets, earbuds, alarms, etc.), one or more audio input devices (e.g., microphones or microphone arrays), location devices (e.g., GPS devices in communication with a satellite-based system to receive a location of the computing device 700, as known in the art), audio codecs, video codecs, printers, sensors (e.g., thermocouples or other temperature sensors, humidity sensors, pressure sensors, vibration sensors, accelerometers, gyroscopes, etc.), image capture devices such as cameras, keyboards, cursor control devices such as a mouse, a stylus, a trackball, or a touchpad, bar code readers, Quick Response (QR) code readers, or radio frequency identification (RFID) readers, for example.

The computing device 700 may have any suitable form factor for its application and setting, such as a handheld or mobile computing device (e.g., a cell phone, a smart phone, a mobile internet device, a tablet computer, a laptop computer, a netbook computer, an ultrabook computer, a personal digital assistant (PDA), an ultra mobile personal computer, etc.), a desktop computing device, or a server computing device or other networked computing component.

One or more computing devices 700 implementing any of the methods disclosed herein may be part of a scientific instrument support system. FIG. 8 is a block diagram of an example scientific instrument support system 800 in which some or all the methods disclosed herein may be performed, in accordance with various implementations. The methods disclosed herein (e.g., the method describe with reference to FIGS. 2A, 2B, 5 and 6) may be implemented by one or more of the scientific instruments 810 (e.g., the gauging or screening instrument 100), the user local computing device 820, the service local computing device 830, or the remote computing device 840 of the scientific instrument support system 800.

Any of the scientific instrument 810, the user local computing device 820, the service local computing device 830, or the remote computing device 840 may include any of the implementations of the computing device 700 discussed herein with reference to FIG. 7, and any of the scientific instrument 810, the user local computing device 820, the service local computing device 830, or the remote computing device 840 may take the form of any appropriate ones of the implementations of the computing device 700 discussed herein with reference to FIG. 7.

The scientific instrument 810, the user local computing device 820, the service local computing device 830, or the remote computing device 840 may each include a processing device 802, a storage device 804, and an interface device 806. The processing device 802 may take any suitable form, including the form of any of the processing devices 702 discussed herein with reference to FIG. 7, and the processing devices 802 included in different ones of the scientific instrument 810, the user local computing device 820, the service local computing device 830, or the remote computing device 840 may take the same form or different forms. The storage device 804 may take any suitable form, including the form of any of the storage devices 704 discussed herein with reference to FIG. 7, and the storage devices 804 included in different ones of the scientific instrument 810, the user local computing device 820, the service local computing device 830, or the remote computing device 840 may take the same form or different forms. The interface device 806 may take any suitable form, including the form of any of the interface devices 706 discussed herein with reference to FIG. 7, and the interface devices 806 included in different ones of the scientific instrument 810, the user local computing device 820, the service local computing device 830, or the remote computing device 840 may take the same form or different forms.

The scientific instrument 810, the user local computing device 820, the service local computing device 830, and the remote computing device 840 may be in communication with other elements of the scientific instrument support system 800 via communication pathways 808. The communication pathways 808 may communicatively couple the interface devices 806 of different ones of the elements of the scientific instrument support system 800, as shown, and may be wired or wireless communication pathways (e.g., in accordance with any of the communication techniques discussed herein with reference to the interface devices 706 of the computing device 700 of FIG. 7). The particular scientific instrument support system 800 depicted in FIG. 8 includes communication pathways between each pair of the scientific instrument 810, the user local computing device 820, the service local computing device 830, and the remote computing device 840, but this “fully connected” implementation is simply illustrative, and in various implementations, various ones of the communication pathways 808 may be absent. For example, in some implementations, a service local computing device 830 may not have a direct communication pathway 808 between its interface device 806 and the interface device 806 of the scientific instrument 810, but may instead communicate with the scientific instrument 810 via the communication pathway 808 between the service local computing device 830 and the user local computing device 820 and the communication pathway 808 between the user local computing device 820 and the scientific instrument 810.

The scientific instrument 810 may include any appropriate scientific instrument, such gauging or x-ray screening instruments 100.

The user local computing device 820 may be a computing device (e.g., in accordance with any of the implementations of the computing device 700 discussed herein) that is local to a user of the scientific instrument 810. In some implementations, the user local computing device 820 may also be local to the scientific instrument 810, but this need not be the case; for example, a user local computing device 820 that is in a user's home or office may be remote from, but in communication with, the scientific instrument 810 so that the user may use the user local computing device 820 to control and/or access data from the scientific instrument 810. In some implementations, the user local computing device 820 may be a laptop, smartphone, or tablet device. In some implementations the user local computing device 820 may be a portable computing device.

The service local computing device 830 may be a computing device (e.g., in accordance with any of the implementations of the computing device 700 discussed herein) that is local to an entity that services the scientific instrument 810. For example, the service local computing device 830 may be local to a manufacturer of the scientific instrument 810, a local user of the scientific instrument 810, or to a third-party service company. In some implementations, the service local computing device 830 may communicate with the scientific instrument 810, the user local computing device 820, and/or the remote computing device 840 (e.g., via a direct communication pathway 808 or via multiple “indirect” communication pathways 808, as discussed above) to receive data regarding the operation of the scientific instrument 810, the user local computing device 820, and/or the remote computing device 840 (e.g., the results of self-tests of the scientific instrument 810, calibration coefficients used by the scientific instrument 810, the measurements of sensors, such as the detectors, associated with the scientific instrument 810, etc.). In some implementations, the service local computing device 830 may communicate with the scientific instrument 810, the user local computing device 820, and/or the remote computing device 840 (e.g., via a direct communication pathway 808 or via multiple “indirect” communication pathways 808, as discussed above) to transmit data to the scientific instrument 810, the user local computing device 820, and/or the remote computing device 840 (e.g., to update programmed instructions, such as firmware, in the scientific instrument 810, to initiate the performance of test or calibration sequences in the scientific instrument 810, to update programmed instructions, such as software, in the user local computing device 820 or the remote computing device 840, etc.). A user of the scientific instrument 810 may utilize the scientific instrument 810 or the user local computing device 820 to communicate with the service local computing device 830 to report a problem with the scientific instrument 810 or the user local computing device 820, to request a visit from a technician to improve the operation of the scientific instrument 810, to order consumables or replacement parts associated with the scientific instrument 810, or for other purposes.

The remote computing device 840 may be a computing device (e.g., in accordance with any of the implementations of the computing device 700 discussed herein) that is remote from the scientific instrument 810 and/or from the user local computing device 820. In some implementations, the remote computing device 840 may be included in a datacenter or other large-scale server environment. In some implementations, the remote computing device 840 may include network-attached storage (e.g., as part of the storage device 804). The remote computing device 840 may store data generated by the scientific instrument 810, perform analyses of the data generated by the scientific instrument 810 (e.g., in accordance with programmed instructions), facilitate communication between the user local computing device 820 and the scientific instrument 810, and/or facilitate communication between the service local computing device 830 and the scientific instrument 810.

In some implementations, one or more of the elements of the scientific instrument support system 800 illustrated in FIG. 8 may not be present. Further, in some implementations, multiple ones of various ones of the elements of the scientific instrument support system 800 of FIG. 8 may be present. For example, a scientific instrument support system 800 may include multiple user local computing devices 820 (e.g., different user local computing devices 820 associated with different users or in different locations). In another example, a scientific instrument support system 800 may include multiple scientific instruments 810, all in communication with service local computing device 830 and/or a remote computing device 840; in such an embodiment, the service local computing device 830 may monitor these multiple scientific instruments 810, and the service local computing device 830 may cause updates or other information may be “broadcast” to multiple scientific instruments 810 at the same time. Different ones of the scientific instruments 810 in a scientific instrument support system 800 may be located close to one another (e.g., in the same room) or farther from one another (e.g., on different floors of a building, in different buildings, in different cities, etc.). In some implementations, a scientific instrument 810 may be connected to an Internet-of-Things (IoT) stack that allows for command and control of the scientific instrument 810 through a web-based application, a virtual or augmented reality application, a mobile application, and/or a desktop application. Any of these applications may be accessed by a user operating the user local computing device 820 in communication with the scientific instrument 810 by the intervening remote computing device 840. In some implementations, a scientific instrument 810 may be sold by the manufacturer along with one or more associated user local computing devices 820 as part of a local scientific instrument computing unit 812.

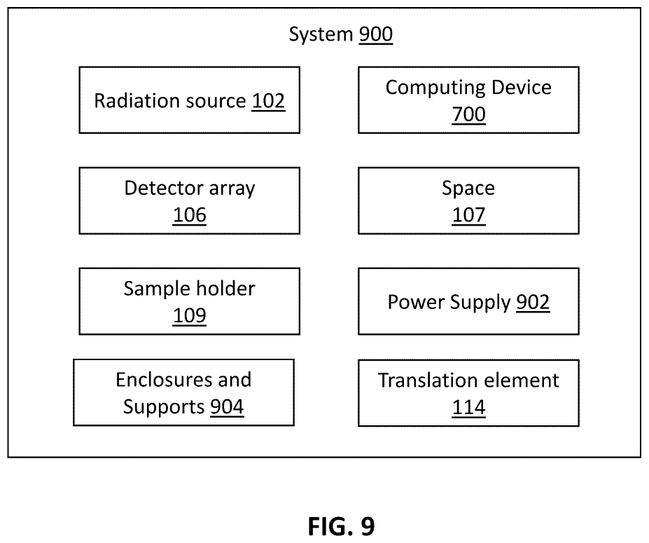

FIG. 9 is a block diagram of a system 900 for checking a gauge response, according to some implementations. The system includes elements that have previously been described: the radiation source 102, the detector array 106 linearly arranged or oriented in the first direction 110, the sample holder 109, the computing device 700, and the space 107 between the source 102 and the detector array 106. The system also includes a power supply 902 such as a mains power supply or a battery. The power supply 902 can be the same as the battery/power 708 that powers the Computing device 700, or the power supply 902 can be a different power supply. In some implementations, the system 900 also includes the translation element 114, such as rollers to translate the web 104 through the space 107.

In some implementations, the system also includes one or more enclosures and supports 904. The one or more supports hold or support the various components so they can function. For example, a supporting frame can hold the source 102 in the correct orientation above the detector array 106. The supports can also hold mechanical elements such as motors that are connected to the sample holder 109 or the translation element 114. Enclosures can be implemented for safety. For example, radiation shielding can be included as part of the enclosures. Enclosures can also be used to partition various elements of the system such as the gauging instrument 100 and the computing device 700.

The following numbered paragraphs 1-15 provide various examples of the embodiments disclosed herein.

Paragraph 1. A method for checking a gauge response comprising: positioning, one at a time, one or more samples with known profiles and uniform compositions in one or more positions between a radiation source and a subset of detectors in a detector array linearly arranged in a first direction; generating sample signals by irradiating the samples with radiation from the radiation source and detecting radiation transmitted through the samples and to the subset of detectors; inputting the sample signals into calibration curves for each of the subset of detectors and each of the one or more samples, thereby determining values corresponding to each of the one or more samples and each of the subset of detectors; and providing a first indication if the values corresponding to the one or more samples are consistent with the know profiles and uniform compositions of the samples.

Paragraph 2. The method according to paragraph 1, wherein each of the one or more samples has a flat and uniform profile.

Paragraph 3. The method according to paragraph 2, wherein each of the one or more samples has a total thickness variation (TTV) of less than 10 microns.

Paragraph 4. The method according to any of paragraph 1-3, wherein more than one sample is used, and each sample has a different thickness or basis weight.

Paragraph 5. The method according to any of paragraphs 1-4, wherein the sample has less than 100 ppm of impurities.

Paragraph 6. The method according to any of paragraphs 1-5, wherein the sample is a semiconductor wafer or a portion thereof.

Paragraph 7. The method according to any of paragraphs 1-6, wherein the sample is a single crystal.

Paragraph 8. The method according to any one of paragraphs 1-7, wherein the sample is a silicon wafer.

Paragraph 9. The method according to any of paragraphs 1-8 further comprising providing a second indication if the values corresponding to the samples are not consistent with the known profiles and uniform compositions of the samples.

Paragraph 10. The method according to any of paragraphs 1-9, where the first indication is provided, and a prompt indicating the detector array calibrations are correct is provided.

Paragraph 11. The method according to any of paragraphs 1-9, wherein the first indication is not provided and one or more calibrations of the detectors in the subset of detectors is adjusted so that inputting the sample signals into the adjusted calibrations provides the values corresponding to the known profiles and uniform compositions of the sample.

Paragraph 12. The method according to paragraph 11 wherein the one or more calibrations of each detector is adjusted by applying a correction to a polynomial fit calibration curve.

Paragraph 13. The method according to any of paragraphs 1-12, wherein a sample is placed in two or more positions by translating the sample in the first direction.

Paragraph 14. The method according to any of paragraphs 1-13, wherein the radiation forms a fan-beam emanating from the source and expanding towards the array of detectors.

Paragraph 15. The method according to any of paragraphs 1-14 further comprising: translating an object in a second direction over the linear array of detectors that are oriented in the first direction; generating object signals by irradiating the object with radiation from the radiation source and detecting radiation transmitted through the object and to the detectors while the object is translated in the second direction; inputting the object signals into the calibration curves for each of the detectors thereby determining values corresponding to the object; generating a topography map of the object; and identifying a streak in the topography map, said streak associated with one or more detectors in the array of detectors showing a peak or trough in object signals relative to adjacent detectors.

Paragraph 16. The method according to paragraph 15, wherein the object is a continuous web.

Paragraph 17. The method according to paragraph 15 or paragraph 16, wherein the object comprises a cathode or anode of a lithium-ion battery, or a precursor thereof.

Paragraph 18. The method according to any of paragraphs 15-17, wherein the first direction is not parallel to the second direction.

Paragraph 19. The method according to any of paragraphs 1-14, wherein the radiation source is an x-ray source and the radiation is x-rays.

Paragraph 20. A system for checking a gauge response comprising; a radiation source; a detector array linearly arranged in a first direction; a sample holder; a space between the source and the detector array; and a computing device having executable code stored thereon, wherein the executable code is configured to send instructions for one or more of: positioning, one at a time, one or more samples with known profiles and uniform compositions that are in the sample holder, in one or more positions between the radiation source and a subset of detectors in the array of detectors; generating sample signals by irradiating the samples with radiation from the radiation source and detecting radiation transmitted through the samples and to the subset of detectors; inputting the sample signals into calibration curves for each of the subset of detectors and each of the one or more samples, thereby determining values corresponding to each of the one or more samples and each of the subset of detectors; and providing a first indication if the values corresponding to the one or more samples are consistent with the known profiles and uniform compositions of the samples.

Paragraph 21. The system according to paragraph 20 further comprising: a translation element configured to translate an object through the space in a second direction that is different from the first direction.

Paragraph 22. The system according to paragraph 21, wherein the translation element is one or more rollers configured to translate a web through the space.

Paragraph 23. The system according to any of paragraphs 20 to 22, wherein the holder can accommodate more than one sample simultaneously.

Paragraph 24. The system according to any of paragraphs 20-23, wherein the sample holder includes an xy stage that can move in the first direction.

Paragraph 25. One or more non-transitory computer readable media having instructions thereon that, when executed by one or more processing devices of a gauging instrument, cause the gauging instrument to perform the method of any one of claims 1-19.

Those having skill in the art, with the knowledge gained from the present disclosure, will recognize that various changes can be made to the disclosed apparatuses and methods in attaining these and other advantages, without departing from the scope of the present disclosure. As such, it should be understood that the features described herein are susceptible to modification, alteration, changes, or substitution. For example, it is expressly intended that all combinations of those elements and/or steps which perform substantially the same function, in substantially the same way, to achieve the same results are within the scope of the embodiments described herein. Substitutions of elements from one described embodiment to another are also fully intended and contemplated. The specific embodiments illustrated and described herein are for illustrative purposes only, and not limiting of that which is set forth in the appended claims. Other embodiments will be evident to those of skill in the art. It should be understood that the foregoing description is provided for clarity only and is merely exemplary. The spirit and scope of the present disclosure is not limited to the above implementation and examples but is encompassed by the following claims. All publications and patent applications cited above are incorporated by reference in their entirety for all purposes to the same extent as if each individual publication or patent application were specifically and individually indicated to be so incorporated by reference.

What is claimed is:

1. A method for checking a gauge response comprising:
positioning, one at a time, one or more samples with known profiles and uniform compositions in one or more positions between a radiation source and a subset of detectors in a detector array linearly arranged in a first direction;
generating sample signals by irradiating the samples with radiation from the radiation source and detecting radiation transmitted through the samples and to the subset of detectors;
inputting the sample signals into calibration curves for each of the subset of detectors and each of the one or more samples, thereby determining values corresponding to each of the one or more samples and each of the subset of detectors; and
providing a first indication if the values corresponding to the one or more samples are consistent with known profiles and uniform compositions of the samples.

2. The method according to claim 1, wherein each of the one or more samples has a flat and uniform profile.

3. The method according to claim 2, wherein each of the one or more samples has a total thickness variation (TTV) of less than 10 microns.

4. The method according to claim 1, wherein more than one sample is used, and each sample has a different thickness or basis weight.

5. The method according to claim 1, wherein the sample has less than 100 ppm of impurities.

6. The method according to claim 1, wherein the sample is a semiconductor wafer or a portion thereof.

7. The method according to claim 1, wherein the sample is a single crystal.

8. The method according to claim 1, wherein the sample is a silicon wafer.

9. The method according to claim 1 further comprising providing a second indication if the values corresponding to the samples are not consistent with the known profiles and uniform compositions of the samples.

10. The method according to claim 1, where the first indication is provided, and a prompt indicating the detector array calibrations are correct is provided.

11. The method according to claim 1, wherein the first indication is not provided and one or more calibrations of the detectors in the subset of detectors is adjusted so that inputting the sample signals into the adjusted calibrations provides the values corresponding to the known profiles and uniform compositions of the sample.

12. The method according to claim 11 wherein the one or more calibrations of each detector is adjusted by applying a correction to a polynomial fit calibration curve.

13. The method according to claim 1, wherein a sample is placed in two or more positions by translating the sample in the first direction.

14. The method according to any of claim 1, wherein the radiation forms a fan-beam emanating from the source and expanding towards the array of detectors.

15. The method according to claim 1 further comprising:
translating an object in a second direction over the detector array that are oriented in the first direction;
generating object signals by irradiating the object with radiation from the radiation source and detecting radiation transmitted through the object and to the detectors while the object is translated in the second direction;
inputting the object signals into the calibration curves for each of the detectors thereby determining values corresponding to the object;
generating a topography map of the object; and
identifying a streak in the topography map, said streak associated with one or more detectors in the array of detectors showing a peak or trough in object signals relative to adjacent detectors.

16. The method according to claim 15, wherein the object is a continuous web.

17. The method according to claim 15, wherein the object comprises a cathode or anode of a lithium-ion battery, or a precursor thereof.

18. The method according to claim 15, wherein the first direction is not parallel to the second direction.

19. The method according to claim 1, wherein the radiation source is an x-ray source and the radiation is x-rays.

20. A system for checking a gauge response comprising:
a radiation source;
a detector array linearly arranged in a first direction;
a sample holder;
a space between the source and the detector array; and
a computing device having executable code stored thereon, wherein the executable code is configured to send instructions for one or more of:
positioning, one at a time, one or more samples with known profiles and uniform compositions that are in the sample holder, in one or more positions between the radiation source and a subset of detectors in the array of detectors;
generating sample signals by irradiating the samples with radiation from the radiation source and detecting radiation transmitted through the samples and to the subset of detectors;
inputting the sample signals into calibration curves for each of the subset of detectors and each of the one or more samples, thereby determining values corresponding to each of the one or more samples and each of the subset of detectors; and
providing a first indication if the values corresponding to the one or more samples are consistent with known profiles and uniform compositions of the samples.

21. The system according to claim 20 further comprising: a translation element configured to translate an object through the space in a second direction that is different from the first direction.

22. The system according to claim 21, wherein the translation element is one or more rollers configured to translate a web through the space.

23. The system according to claim 20, wherein the holder can accommodate more than one sample simultaneously.

24. The system according to claim 20, wherein the sample holder includes an xy stage that can move in the first direction.

25. One or more non-transitory computer readable media having instructions thereon that, when executed by one or more processing devices of a gauging instrument, cause the gauging instrument to perform the method of claim 1.
